(19) United States
(12) Patent Application Publication
(10) Pub. No.: US 2015/0098043 A1
(43) Pub. Date: Apr. 9, 2015

(54) LIQUID CRYSTAL DISPLAY DEVICE

(71) Applicant: Japan Display Inc., Tokyo (JP)

(72) Inventor: Shohei MATSUMOTO, Tokyo (JP)

(73) Assignee: Japan Display Inc.

(21) Appl. No.: 14/503,434

(22) Filed: Oct. 1, 2014

(30) Foreign Application Priority Data
Oct. 3, 2013 (JP) 2013-207879

(51) Int. Cl. F21V 8/00; G02F 1/1333; G02F 1/1335

(52) U.S. Cl. CPC G02B 6/009; G02F 1/133615; G02F 1/133308
USPC 349/58; 349/65

(57) ABSTRACT

The present invention provides a liquid crystal display device having a liquid crystal display panel and a backlight unit provided on a rear surface of the liquid crystal display panel, where the backlight unit has light emitting diodes LED, a light guiding plate LG for guiding light emitted from the light emitting diodes, a reflector sheet RS provided on a rear surface of the light guiding plate LG, and a flexible printed circuit board FPC onto which the light emitting diodes are mounted, and an auxiliary sheet SS, and one part of the reflector sheet RS faces a part of the flexible printed circuit board FPC, and another part of the reflector sheet RS faces the auxiliary sheet SS.

### CROSS-REFERENCE TO RELATED APPLICATION

The present application claims priority over Japanese Patent Application JP2013-207879 filed on Oct. 3, 2013, the contents of which are hereby incorporated into this application by reference.

### BACKGROUND OF THE INVENTION

1. Field of the Invention

The present invention relates to a liquid crystal display device, and in particular, to a liquid crystal display device where a protective plate is provided on the front surface of the liquid crystal display panel, and a backlight unit having a backlight frame is provided on the rear surface of the liquid crystal display panel.

2. Description of Related Art

Liquid crystal display devices of which the thickness has been reduced are used as the display device of a portable information unit such as mobile phones, personal digital assistants (PDA), digital cameras, and multimedia players.

FIG. 1 is a plan diagram showing a conventional liquid crystal display device. FIG. 2 is a cross-sectional diagram along a single-dotted chain line A-A′ in FIG. 1. FIG. 3 is a cross-sectional diagram along a single-dotted chain line B-B′ in FIG. 1. The liquid crystal display device has as its main components: a liquid crystal display panel where a liquid crystal layer is sealed between a pair of transparent substrates (S1, S2) such as of glass, a polarizing plate PP1 is provided on the front surface side of the substrate S1, and a polarizing plate PP1 is provided on the rear surface side of the substrate S2; and a backlight unit provided on the rear surface of the liquid crystal display panel.

As shown in FIG. 3, the backlight unit is formed so as to include light sources LED such as light emitting diodes, a light guiding plate LG that guides light from the light sources, a reflector sheet RS that is provided on the rear surface of the light guiding plate LG so as to return the light emitted from the rear surface of the light guiding plate to the light guiding plate LG, and an optical sheet OS for adjusting the intensity distribution and the direction of the light emitted from the front surface of the light guiding plate LG.

As shown in FIGS. 2 and 3, the light emitting diodes LED, the light guiding plate LG, and the optical sheet OS that form the backlight unit are supported on a side by a mold frame MF formed of a resin or the like. A lower frame SF having high rigidity such as of a metal is provided on the rear surface side of the backlight unit so as to support the mold frame MF and the parts contained inside the mold frame MF on the rear surface and on the lateral side in the configuration. Here, the lower frame is not shown in FIG. 1.

The liquid crystal display panel is provided on the front surface side of the mold frame MF, and part of the substrate S2 and part of the mold frame MF are connected through an adhesive layer (an adhesive or an adhesive tape) AD1 as shown in FIGS. 2 and 3.

An IC chip CP that includes a drive circuit for image display is provided on a portion of the substrate S2 that forms the liquid crystal display panel, and furthermore, a flexible printed circuit board FPC having wires for supplying a drive signal and the like to the liquid crystal display panel is electrically connected to a portion of the substrate S2. In addition, part of the flexible printed circuit board FPC is used to supply electricity to the light emitting diodes LED, and thus is led out onto the rear surface side of the liquid crystal display device shown in FIG. 3. The flexible printed circuit board FPC is connected to the mold frame MF through an adhesive layer AD3.

As shown in FIG. 2, the reflector sheet RS that forms the backlight unit is fixed to and supported on the rear surface side of the mold frame MF through an adhesive layer (an adhesive or an adhesive tape) AD2. Meanwhile, the demand on narrowing the frame of liquid crystal display devices has become stronger, and in order to achieve this, as shown in FIG. 4A, it is required to make the portion that protrudes to the left from the end of the image display region DA, shown as a dotted line, as narrow as possible. In order to do this, as shown in FIG. 4B, it is necessary to make the width of the mold frame MF narrow, and together with this, the width of the adhesive layer AD2 (length in the left to right direction in the figure) needs to be narrower. Therefore, such a problem arises that the adhesive layer AD2 cannot sufficiently hold the reflector sheet RS, and in some cases, the connection is broken, making it impossible to fix the reflector sheet RS in a predetermined position.

JP 2005-376753A discloses a technology for connecting one end of a flexible printed circuit board on which light emitting diodes are provided to one end of the rear surface of a reflector sheet by means of a double-sided adhesive tape. When this structure is applied to the liquid crystal display device shown in FIGS. 1 to 3, however, the reflector sheet is lifted up from the lower frame by the thickness of the flexible printed circuit board and the double-sided adhesive tape in the configuration. The reflector sheet and the light guiding plate are not connected to each other through the major parts, but rather are simply located in close proximity to each other, and therefore, the reflector sheet flaps in the space between the reflector sheet and the lower frame, which causes illumination to be uneven in the backlight unit.

### SUMMARY OF THE INVENTION

An object of the present invention is to provide a liquid crystal display device where the reflector sheet is stably held while making it possible to narrow the frame without causing the above-described problems.

In order to achieve the above-described object, the liquid crystal display device according to the present invention has the following technological features.

(1) A liquid crystal display device having a liquid crystal display panel and a backlight unit provided on a rear surface of the liquid crystal display panel is characterized in that the backlight unit has light emitting diodes, a light guiding plate for guiding light emitted from the light emitting diodes, a reflector sheet provided on a rear surface of the light guiding plate, a flexible printed circuit board onto which the light emitting diodes are mounted, and an auxiliary sheet, and one part of the reflector sheet faces a part of the flexible printed circuit board, and another part of the reflector sheet faces the auxiliary sheet.
(2) The liquid crystal display device according to the above (1) is characterized by further having a lower frame that supports the light emitting diodes, the light guiding plate, the reflector sheet, and the flexible printed circuit board on the rear surface side of the backlight unit, where a part of the flexible printed circuit board and the auxiliary sheet are located between the lower frame and the reflector sheet.
(3) The liquid crystal display device according to the above (1) or (2) is characterized in that the auxiliary sheet has a thickness that is approximately as thick as the flexible printed circuit board.
(4) The liquid crystal display device according to the above (1) or (2) is characterized in that the backlight unit comprises a mold frame that contains the light emitting diodes and the light guiding plate and supports the liquid crystal display panel, the reflector sheet is located on a rear surface of the mold frame, and the reflector sheet is movable relative to the mold frame.
(5) The liquid crystal display device according to the above (1) or (2) is characterized in that the reflector sheet and the light guiding plate are connected to each other through an adhesive layer, and the adhesive layer is provided in a region that does not face light emitting portions of the light emitting diodes as viewed from the top.

According to the present invention, a liquid crystal display device having a liquid crystal display panel and a backlight unit provided on a rear surface of the liquid crystal display panel is formed in such a manner that the backlight unit has light emitting diodes, a light guiding plate for guiding light emitted from the light emitting diodes, a reflector sheet provided on a rear surface of the light guiding plate, a flexible printed circuit board onto which the light emitting diodes are mounted, and an auxiliary sheet, and one part of the reflector sheet faces a part of the flexible printed circuit board, and another part of the reflector sheet faces the auxiliary sheet, and therefore, the flexible printed circuit board and the auxiliary sheet are located on the rear surface side of the reflector sheet. For this reason, it makes it possible to hold the reflector sheet stably without the connection between the reflector sheet and the mold frame through an adhesive layer. As a result, a liquid crystal display device where illumination can be prevented from becoming uneven due to a shift of the reflector sheet while achieving the narrowing of the frame can be provided.

### BRIEF DESCRIPTION OF THE DRAWINGS

FIG. 1 is a plan diagram showing an example of a conventional liquid crystal display device;

FIG. 2 is a cross-sectional diagram along single-dotted chain line A-A′ in FIG. 1;

FIG. 3 is a cross-sectional diagram along single-dotted chain line B-B′ in FIG. 1;

FIGS. 4A and 4B are cross-sectional diagrams corresponding to FIG. 2 for illustrating the manner of a case where the frame is narrower in a conventional liquid crystal display device;

FIG. 5 is a plan diagram showing an example of the liquid crystal display device according to the present invention;

FIG. 6 is a cross-sectional diagram along single-dotted chain line C-C′ in FIG. 5;

FIG. 7 is a cross-sectional diagram along single-dotted chain line D-D′ in FIG. 5; and

FIG. 8 is a plan diagram showing a modification of the liquid crystal display device according to the present invention as viewed from the bottom, where the lower frame and the reflector sheet are not shown.

### DETAILED DESCRIPTION OF EMBODIMENTS

In the following, the preferred embodiments of the present invention are described in detail.

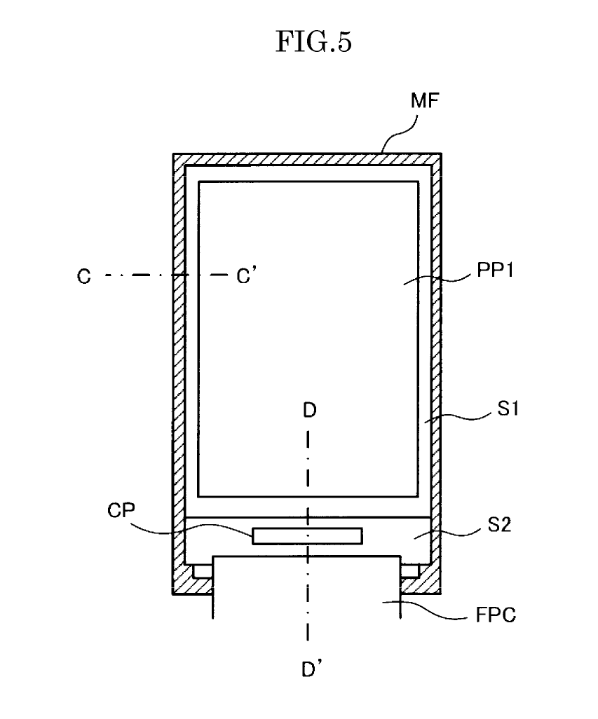

As shown in FIGS. 5 to 7, the present invention provides a liquid crystal display device having a liquid crystal display panel and a backlight unit provided on a rear surface of the liquid crystal display panel, and is characterized in that the backlight unit has light emitting diodes LED, a light guiding plate LG for guiding light emitted from the light emitting diodes, a reflector sheet RS provided on a rear surface of the light guiding plate LG, and a flexible printed circuit board FPC onto which the light emitting diodes are mounted, and an auxiliary sheet SS, and one part of the reflector sheet RS faces a part of the flexible printed circuit board FPC, and another part of the reflector sheet RS faces the auxiliary sheet SS.

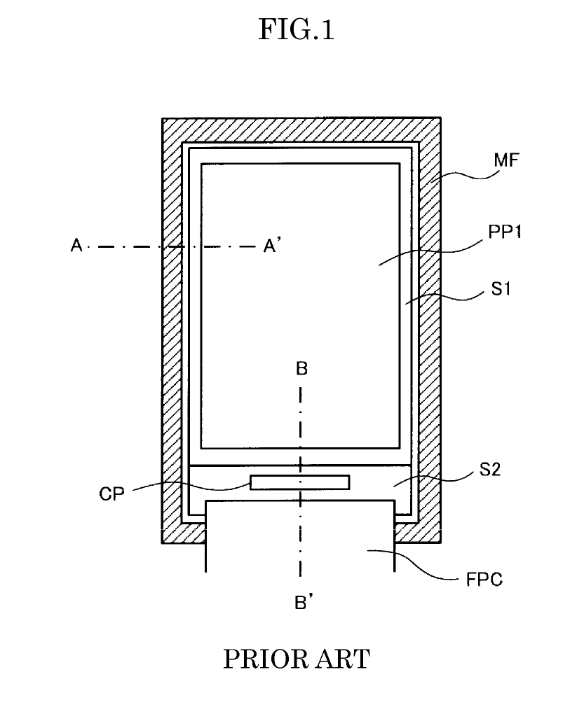

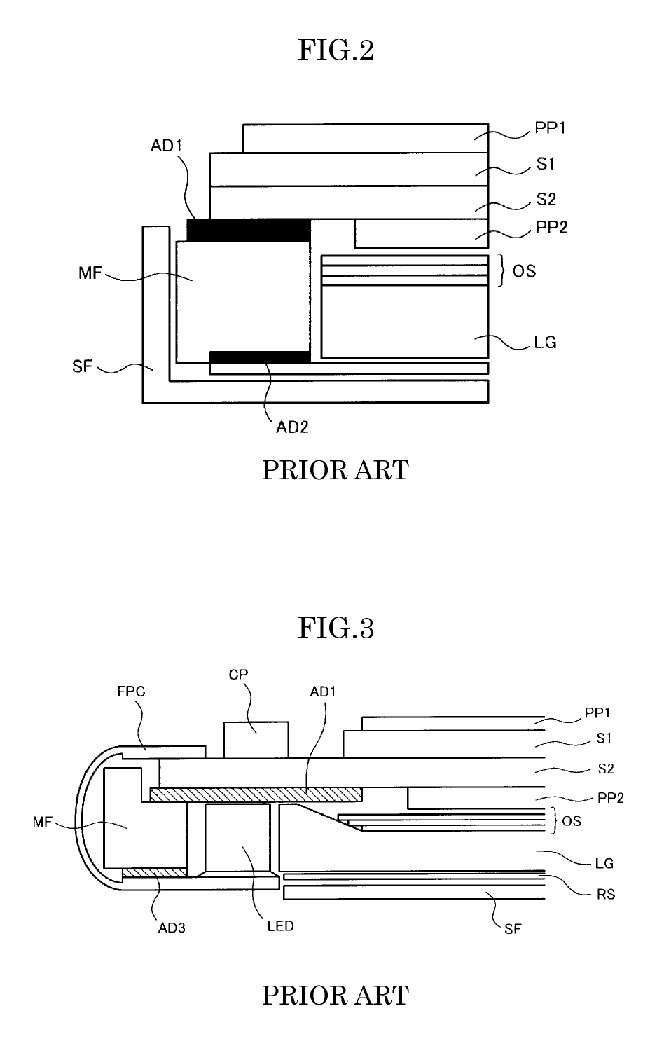

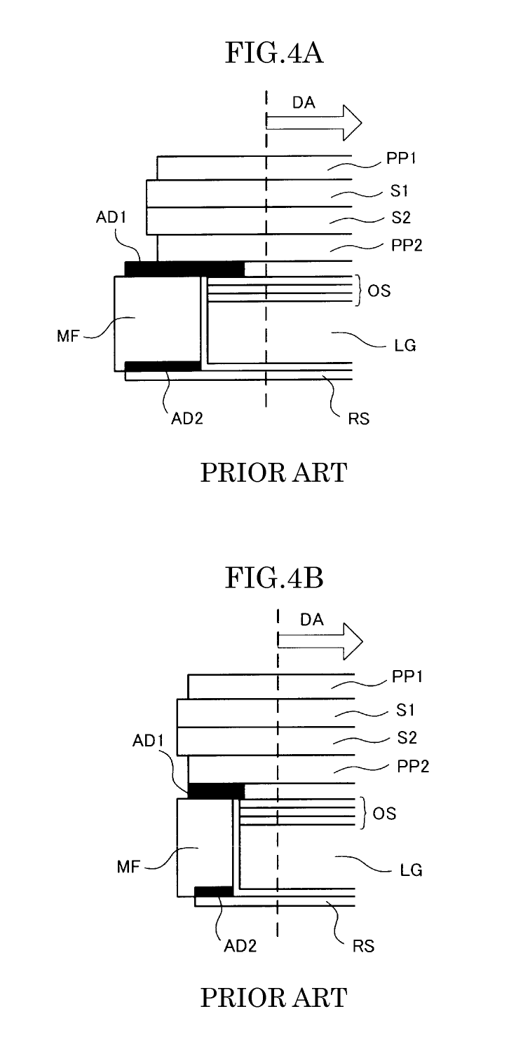

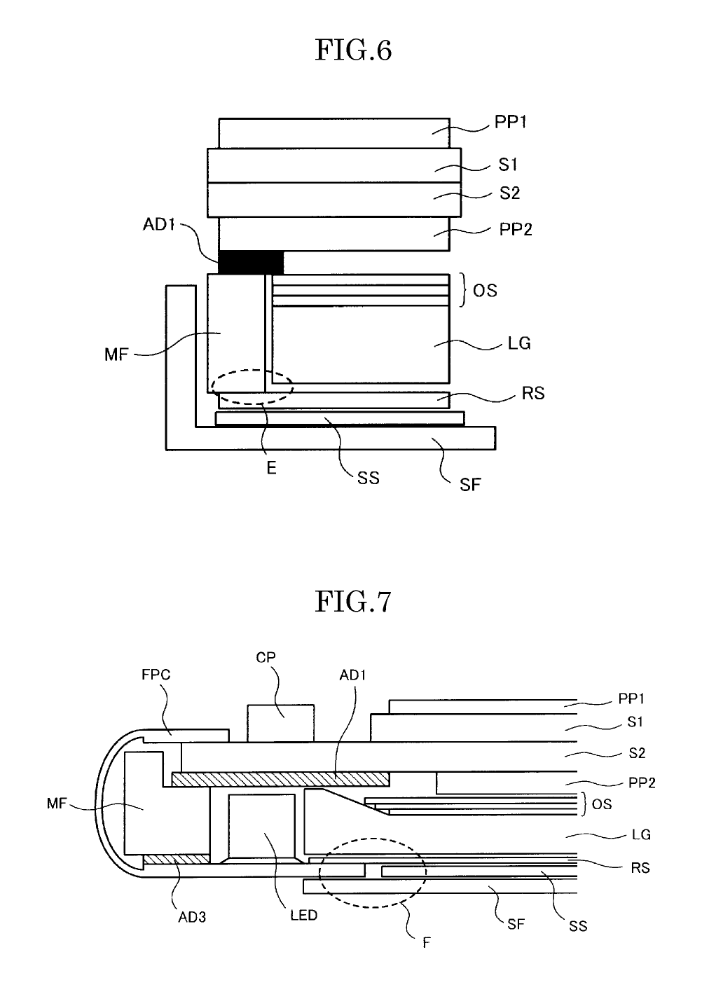

The basic structure of the liquid crystal display devices shown in FIGS. 5 to 7 is the same as that of the conventional liquid crystal display device shown in FIGS. 1 to 3. The same symbols are attached to the same parts. FIG. 5 is a plan diagram showing the liquid crystal display device. FIG. 6 is a cross-sectional diagram along single-dotted chain line C-C′ in FIG. 5. FIG. 7 is a cross-sectional diagram along single-dotted chain line D-D′ in FIG. 5.

The liquid crystal display device according to the present invention has as its main components: a liquid crystal display panel where a liquid crystal layer is sealed between a pair of transparent substrates (S1, S2) such as of glass, a polarizing plate PP1 is provided on the front surface side of the substrate S1, and a polarizing plate PP1 is provided on the rear surface side of the substrate S2; and a backlight unit provided on the rear surface of the liquid crystal display panel.

As shown in FIG. 7, the backlight unit is formed so as to include light sources LED such as light emitting diodes, a light guiding plate LG that guides light from the light sources, a reflector sheet RS that is provided on the rear surface of the light guiding plate LG so as to return the light emitted from the rear surface of the light guiding plate to the light guiding plate LG, and an optical sheet OS for adjusting the intensity distribution and the direction of the light emitted from the front surface of the light guiding plate LG.

As shown in FIGS. 6 and 7, the light emitting diodes LED, the light guiding plate LG, and the optical sheet OS that form the backlight unit are supported on a side by a mold frame MF formed of a resin or the like. A lower frame SF having high rigidity such as of a metal is on the rear surface side of the backlight unit so as to support the mold frame MF and the parts contained inside the mold frame MF on the rear surface and on the lateral side in the configuration. Here, the lower frame is not shown in FIG. 5.

The liquid crystal display panel is provided on the front surface side of the mold frame MF, and part of the substrate S2 and part of the mold frame MF are connected through an adhesive layer (an adhesive or an adhesive tape) AD1 as shown in FIGS. 6 and 7.

An IC chip CP that includes a drive circuit for image display is provided on a portion of the substrate S2 that forms the liquid crystal display panel. Furthermore, a flexible printed circuit board FPC having wires for supplying a drive signal and the like to the liquid crystal display panel is electrically connected to a portion of the substrate S2. In addition, part of the flexible printed circuit board FPC is used to supply electricity to the light emitting diodes LED, and thus is led out onto the rear surface side of the liquid crystal display device shown in FIG. 7. The flexible printed circuit board FPC is connected to the mold frame MF through an adhesive layer AD3.

A part of the flexible printed circuit board FPC is provided on the rear surface of the light guiding plate LG and faces a part of the reflector sheet RS. In addition, a part of the reflector sheet RS that is different from the part that faces the flexible printed circuit board FPC faces the auxiliary sheet SS.

As shown in region F within the dotted oval in FIG. 7, the liquid crystal display device according to the present invention is mainly characterized in the configuration where the reflector sheet RS is sandwiched between the light guiding plate LG and the flexible printed circuit board FPC, and at the same time, the auxiliary sheet SS is located between the reflector sheet RS and the lower frame SF in a portion of the rear surface of the reflector sheet RS where the flexible printed circuit board FPC is not provided.

In the case where the width of the mold frame MF in FIG. 6 is reduced in order to satisfy the demand on narrowing the frame, it is difficult to provide a stable adhesive layer (a double-sided adhesive tape or an adhesive) on the rear surface side of the mold frame MF. Therefore, as shown in region E within the dotted oval, the reflector sheet RS extends along part of the rear surface of the mold frame MF where no adhesive layer is interposed between the mold frame MF and the reflector sheet RS. As a result, the reflector sheet RF is movable relative to the mold frame MF and the reflector sheet RS cannot be held.

According to the prior art, the liquid crystal display device (liquid crystal display module) has a mandatory condition when formed as a single body that the mold frame and the reflector sheet in the backlight unit should be prevented from peeling off from each other due to the prescribed mechanical or physical stress, though no adhesive layer can be used in the above-described thin mold frame of which the width has been narrowed, and thus, this mandatory condition cannot be satisfied.

Liquid crystal display devices (liquid crystal display modules) may have a lower frame or may be ultimately contained within another housing such as that of a portable phone, and therefore, the mold frame and the reflector sheet are held within a frame or a housing in the upward and downward directions or in other directions. As a result, it is not considered to cause any substantial problems even in the case where the mold frame and the reflector sheet are loosely fixed to each other in such a state that the liquid crystal display device is provided as a single body as long as the two are not separated from each other during the transportation period before the liquid crystal display device arrives at its destination (before being contained within another housing).

Under the above-described assumption, the present invention provides a structure where the reflector sheet RS is held between the light guiding plate LG and the flexible printed circuit board FPC.

According to the present invention, as shown in FIGS. 6 and 7, the auxiliary sheet SS is located between the reflector sheet RS and the lower frame SF. Naturally, the thickness of the auxiliary sheet SS can be made approximately the same as the thickness of the flexible printed circuit board FPC so that the space between the reflector sheet RS and the lower frame SF, which is created by the flexible printed circuit board FPC, can almost be filled in with the auxiliary sheet, and thus, it is possible to hold the reflector sheet RS more stably.

The thickness of the auxiliary sheet SS is 0.8 to 1.2 times greater than the thickness of the flexible printed circuit board FPC in the portion facing the reflector sheet RS, for example. The auxiliary sheet SS holds the reflector sheet RS stably, and thus, the light that has leaked from the light guiding plate to the rear surface side can be appropriately returned to the light guiding plate by the reflector sheet RS. Accordingly, the auxiliary sheet SS can further reduce the unevenness in the illumination by light emitted from the backlight unit.

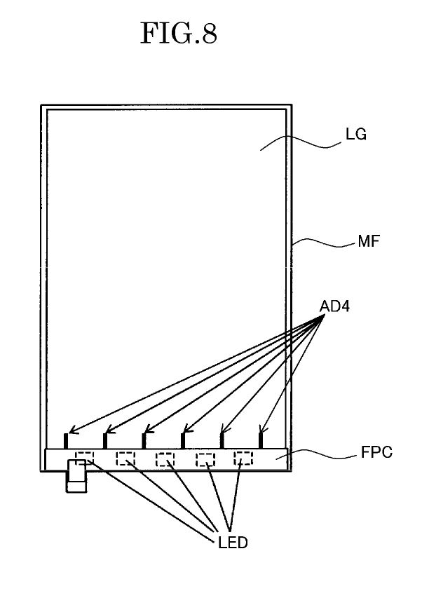

In addition, the reflector sheet RS, which is held between the light guiding plate LG and the flexible printed circuit board FPC, may be fixed to the light guiding plate LG through an adhesive layer AD4 (a double-sided adhesive tape or an adhesive, for example) on the side where the light emitting diodes LED are located. FIG. 8 is a plan diagram showing the positional relationship between the above-described light emitting diodes, the light guiding plate LG, and the adhesive layer AD4 as viewed from the side opposite to the liquid crystal display panel, where the lower frame SF and the reflector sheet RS are not shown. As shown in FIG. 8, it is desirable for the adhesive layer AD4 (a double-sided adhesive tape or an adhesive, for example) to be provided in a location that does not face the front of the light emitting portions of the light emitting diodes LED as viewed from the top, that is to say, in a location outside the regions of light emissions. This configuration allows the adhesive layer AD4 to reduce the dispersion of light, and thus can maintain high display quality.

As shown in FIG. 8, the adhesive layer AD4 is provided in locations between adjacent light emitting diodes LED on the rear surface of the light guiding plate LG or in a location outside the alignment of the light emitting diodes LED. In addition, as shown in FIG. 8, the adhesive layer AD4 is provided so as to extend from the end of the light guiding plate LG that faces the light emitting diodes LED toward the inside of the light guiding plate LG (in the upward direction in FIG. 8). The length of the adhesive layer AD4 (length in the upward and downward directions in FIG. 8) is set to such a length as not to block the light emitted from the light emitting diodes LED.

What is claimed is:

1. A liquid crystal display device, comprising a liquid crystal display panel and a backlight unit provided on a rear surface of the liquid crystal display panel, wherein
the backlight unit comprises light emitting diodes, a light guiding plate for guiding light emitted from the light emitting diodes, a reflector sheet provided on a rear surface of the light guiding plate, a flexible printed circuit board onto which the light emitting diodes are mounted, and an auxiliary sheet, and
one part of the reflector sheet faces a part of the flexible printed circuit board, and another part of the reflector sheet faces the auxiliary sheet.

2. The liquid crystal display device according to claim 1, further comprising a lower frame that supports the light emitting diodes, the light guiding plate, the reflector sheet, and the flexible printed circuit board on the rear surface side of the backlight unit, where
a part of the flexible printed circuit board and the auxiliary sheet are located between the lower frame and the reflector sheet.

3. The liquid crystal display device according to claim 1, wherein the auxiliary sheet has a thickness that is approximately as thick as the flexible printed circuit board.

4. The liquid crystal display device according to claim 1, wherein
the backlight unit comprises a mold frame that contains the light emitting diodes and the light guiding plate and supports the liquid crystal display panel,
the reflector sheet is located on a rear surface of the mold frame, and
the reflector sheet is movable relative to the mold frame.

5. The liquid crystal display device according to claim 1, wherein
the reflector sheet and the light guiding plate are connected to each other through an adhesive layer, and
the adhesive layer is provided in a region that does not face light emitting portions of the light emitting diodes as viewed from the top.

6. The liquid crystal display device according to claim 2, wherein the auxiliary sheet has a thickness that is approximately as thick as the flexible printed circuit board.

7. The liquid crystal display device according to claim 2, wherein
the backlight unit comprises a mold frame that contains the light emitting diodes and the light guiding plate and supports the liquid crystal display panel,
the reflector sheet is located on a rear surface of the mold frame, and
the reflector sheet is movable relative to the mold frame.

8. The liquid crystal display device according to claim 2, wherein
the reflector sheet and the light guiding plate are connected to each other through an adhesive layer, and
the adhesive layer is provided in a region that does not face light emitting portions of the light emitting diodes as viewed from the top.
